(19) United States
(12) Patent Application Publication
(10) Pub. No.: US 2021/0184799 A1
(43) Pub. Date: Jun. 17, 2021

(54) HARQ PROCESSING IN A FREQUENCY DIVISION DUPLEXING-BASED RADIO COMMUNICATION NETWORK

(71) Applicant: Alcatel Lucent, Boulogne Billancourt (FR)

(72) Inventors: Hua Chao, Shanghai (CN); Yonggang Wang, Shanghai (CN); Yu Chen, Shanghai (CN); Wei Xiong, Whitehouse Station, NJ (US); He Wang, Shanghai (CN)

(73) Assignee: Alcatel Lucent, Boulogne Billancourt (FR)

(21) Appl. No.: 16/074,238

(22) PCT Filed: Jan. 17, 2017
(86) PCT No.: PCT/IB2017/000148

§ 371 Date: Jul. 31, 2018

(30) Foreign Application Priority Data
Feb. 5, 2016 (CN) 201610082956.X

(51) Int. Cl. H04L 1/18; H04L 5/14

(52) U.S. Cl. CPC H04L 1/1812; H04L 5/14

(57) ABSTRACT

The present invention provides a method and apparatus for assigning user equipment HARQ time and base station HARQ time in a radio communication network, wherein the user equipment HARQ time is for the user equipment to process the HARQ process, the base station HARQ time is for the base station to process the HARQ process, the user equipment HARQ time being longer than the base station HARQ time.

### FIELD OF THE INVENTION

The present disclosure relates to HARQ processing in a radio communication network, and more specifically to a method and apparatus for HARQ processing in a frequency division duplexing-based radio communication network.

### BACKGROUND OF THE INVENTION

A long term evolution (LTE) technology supports two duplexing manners: frequency division duplexing (FDD), and time division duplexing (TDD).

In the 67 #meeting of the RAN (Radio Access Network) TSG (Technical Specification Group) of the 3^{rd} Generation Partnership Project (3GPP), a study project regarding how to shorten latency was passed. This project intends to study the feasibility and optional schemes for shortening latency. According to the study of RAN2, the latency in LTE and LTE-A networks is caused to a great extent by round-trip delay (RTD) of HARQ (Hybrid Automatic Repeat request); therefore, it is one of important study tasks to optimize HARQ processing.

Besides, a preliminary study conclusion of RAN2 indicates that shortening of a transmission time interval (TTI) can effectively shorten the latency. The shorted TTI is also referred to as sTTI whose length may be one or more OFDM symbols (OSs). The sTTI provides new requirements on HARQ processing, which cannot be satisfied by existing HARQ processing schemes.

### SUMMARY OF THE INVENTION

A downlink portion of traffic data is transmitted over a physical downlink shared channel (PDSCH), while an uplink portion is transmitted over a physical uplink shared channel (PUSCH).

A HARQ feedback (e.g., HARQ-ACK or HARQ-NACK) of PDSCH may be transmitted over a physical uplink shared channel or a physical uplink control channel. The HARQ feedback of the PUSCH is transmitted over a physical hybrid ARQ indicator channel. According to specific designs of the uplink HARQ and the downlink HARQ, a temporal relationship involved in the HARQ between a certain data/message and previous/subsequent feedback/data/message is referred to as HARQ timing.

After a UE selects an appropriate cell to reside in, it may initiate an initial random access process. In the LTE, random access is a basic function. The UE can be scheduled by the system to perform uplink transmission only after being uplink synchronized with the system through a random access process. The random access in the LTE has two forms: contention-based random access and contention-free random access. The initial random access process is a contention-based access process, which may be divided into four steps:

(1): preamble sequence transmission;

(2): random access response (RAR);

(3): MSG3 transmission (RRC Connection Request);

(4) contention resolution message (MSG4).

The MSG3 refers to a third message. Because contents of messages during the random access process are not fixed, which sometimes might carry a RRC connection request and sometimes might carry some control messages or even traffic packets, such messages are shortly referred to as MSG3. A process of transmitting the MSG3 also employs an HARQ mechanism; however, because decoding of an RAR message needs a longer time, the existing protocols define a longer HARQ timing for MSG3. On the basis, the present disclosure also involves MSG3 in optimizing the HARQ processing.

For example, in current specifications, for FDD and TDD, definitions of the HARQ timing processing are all directed to scenarios in which the TTI length is 1 millisecond. In order to achieve the objective of shortening the overall delay, the length of the TTI needs to be shortened; therefore, how to provide an adapted HARQ timing solution for these shorter TTIs is an issue intended to be solved by the Inventors of the present disclosure through the embodiments of the present disclosure.

According to embodiments of a first aspect of the present disclosure, there is provided a first assigning apparatus for assigning user equipment HARQ time in a user equipment of a radio communication network, the user equipment HARQ time being for the user equipment to process an HARQ process, wherein the user equipment HARQ time assigned by the first assigning apparatus is longer than a base station HARQ time assigned by a base station, the base station HARQ time being for the base station to process the HARQ process.

Further, the user equipment HARQ time is shorter than a time interval between a third message and a random access response message between the user equipment and the base station.

Further, the first assigning apparatus is configured to determine the user equipment HARQ time based on a processing capability of the user equipment.

Further, the first assigning apparatus is configured such that user equipment HARQ time determined based on different user equipment processing capability levels is different.

Further, the first assigning apparatus further comprises:

a first HARQ mode determining module configured to determine an HARQ mode between the base station and the user equipment, wherein the HARQ model is dependent on at least one of the following items:
a coverage area of the cell;
a distance between the base station and the user equipment;
transmission time interval (TTI) length;
processing capability of the user equipment.

Further, the first HARQ mode determining module is configured to determine, for data received on the n^{th} TTI, to transmit an HARQ process processing result after m TTIs, wherein determining of m follows the equation below:

m=RTT/TTI/2,

where RTT denotes an HARQ round-trip time, TTI denotes a length of transmission time internal, and RTT is further denoted as: RTT=2PD+2TTI+D_{UE}+D_{eNB}, where PD denotes a maximum propagation delay between the base station and the user equipment, 2TTI denotes time occupied by data/feedback/message transmission, D_{UE} denotes processing delay at the UE, and D_{eNB} denotes processing delay at the base station.

Further, D_{UE} is further represented as m_{UE}*TTI+FD_{UE}, wherein m_{UE}*TTI is a portion varying with a TTI length in a HARQ process processing delay of the UE, FD_{UE} is a portion not varying with TTI in the HARQ process processing of the UE, and D_{eNB} is further represented as m_{eNB}*TTI+FD_{eNB}, where m_{eNB}*TTI is a portion varying with TTI length in an HARQ process processing delay of the base station, and FD_{eNB} is a portion not varying with TTI in the HARQ process processing delay of the base station.

According to embodiments of the second aspect of the present disclosure, there is provided a second assigning apparatus for assigning base station HARQ time in a base station of a radio communication network, the base station HARQ time being for the base station to process an HARQ process, where the base station HARQ time assigned by the second assigning apparatus is shorter than a user equipment HARQ time assigned by the user equipment, the user equipment HARQ time being for the user equipment to process the HARQ process.

Further, the user equipment HARQ time is shorter than a time interval between a radio resource control request message and a random access response message between the user equipment and the base station.

Further, the second assigning apparatus also comprises:

a second HARQ mode determining module configured to determine an HARQ mode between the base station and the user equipment, wherein the HARQ mode is dependent on at least any one of the following items:
cell coverage;
distance between the base station and the user equipment;
transmission time interval (TTI) length;
processing capability of the user equipment.

Further, the second HARQ mode determining module is configured to determine, for data received on the n^{th} TTI, to transmit an HARQ process processing result after m TTIs, wherein determining of the m follows the equation below:

m=RTT/TTI/2,

where RTT denotes an HARQ round-trip time, TTI denotes a length of a transmission time interval, and the RTT is further represented as: RTT=2PD+2TTI+D_{UE}+D_{eNB}, wherein PD denotes a maximum propagation delay between the base station and the user equipment, 2TTI denotes time occupied by transmitting the data/feedback/message, DUE denotes processing delay at the UE, and DeNB denotes processing delay at the base station.

Further, D_{UE} is further represented as m_{UE}*TTI+FD_{UE}, wherein m_{UE}*TTI is a portion varying with TTI length in an HARQ process processing delay of the UE, FD_{UE} is a portion not varying with the TTI in the HARQ process processing delay of the UE, and D_{eNB} is further represented as m_{eNB}*TTI+FD_{eNB}, wherein m_{eNB}*TTI denotes a portion varying with TTI length in the HARQ process processing delay of the base station, and FD_{eNB} is the portion not varying with TTI of the HARQ process processing delay of the base station.

According to embodiments of a third aspect of the present disclosure, there is provided a user equipment in a radio communication network, comprising a first assigning apparatus in the embodiments of the first aspect mentioned above.

According to embodiments of a fourth aspect of the present disclosure, there is provided a radio base station, comprising a second assigning apparatus in the embodiments of the second aspect mentioned above.

According to embodiments of a fifth aspect of the present disclosure, there is provided a method of assigning user equipment HARQ time and base station HARQ time in a radio communication network, wherein the user equipment HARQ time is for the user equipment to process an HARQ process, the base station HARQ time is for the base station to process the HARQ process, the user equipment HARQ time being longer than the base station HARQ time.

By implementing the embodiments of the present disclosure, the following effects may be achieved:

by optimizing the HARQ processing, RTT is effectively shortened, which is very helpful to shorten the overall delay;

a specific solution is provided for the standard;

different UE processing capability levels and multiple sTTI modes are supported, thereby providing a sufficient flexibility for specific implementations;

different cell coverages are supported to facilitate network deployment.

### BRIEF DESCRIPTION OF THE ACCOMPANYING DRAWINGS

The present disclosure will be understood more thoroughly through the detailed description and drawings provided below, wherein same units are indicated by a same reference numeral; the drawings are provided only for illustrative purposes, not intended to limit the present disclosure, wherein:

FIG. 1 illustrates a HARQ timing scheme in an FDD system according to embodiments of the present disclosure;

FIG. 2a illustrates a process of transmitting parameters of HARQ in one scenario according to embodiments of the present disclosure;

FIG. 2b illustrates a process of transmitting parameters of HARQ in another scenario according to embodiments of the present disclosure;

FIG. 3 illustrates a schematic block diagram of a first assigning apparatus that assigns user equipment HARQ time in a user equipment of a radio communication network according to embodiments of the present disclosure;

FIG. 4 illustrates a schematic block diagram of a second assigning apparatus that assigns base station HARQ time in a base station of a radio communication network according to embodiments of the present disclosure.

It should be understood that these drawings intend to illustrate general characteristics of a method, structure and/or material used in some exemplary embodiments to make supplementations to the written depictions provided hereinafter. However, these drawings are not drawn proportionally and possibly do not accurately reflect an accurate structure or performance characteristic of any given embodiment, and should not be interpreted as defining or limiting a scope of numerical values or attributes covered by the exemplary embodiments. Use of similar or completely identical reference numerals in the drawings is to indicate existing of the similar or completely identical units or features.

### DETAILED DESCRIPTION OF THE PREFERRED EMBODIMENTS

Although exemplary embodiments may have various modification and substitution manners, and some embodiments therein are illustrated exemplarily in the drawings and will be described in detail here, it should be understood that the exemplary embodiments are not intended to be limited to the specific forms as disclosed. On the contrary, the exemplary embodiments intend to cover all modifications, equivalent schemes and alternative schemes falling within the scope of the claims. Same reference numerals always represent same units in depictions of respective drawings.

It should be mentioned before discussing the exemplary embodiments in more detail that some exemplary embodiments are described as processing or methods in the form of flow diagrams. Although a flow diagram depicts respective operations as being sequentially processed, many operations therein may be implemented in parallel, concurrently or simultaneously. Besides, Various operations may be re-ordered. When the operations are completed, the processing may be terminated. However, there may comprise additional steps not included in the accompanying drawings. The processing may correspond to a method, a function, a specification, a sub-routine, a sub-program, etc.

The term “wireless device” or “device” used here may be regarded as synonymous to the following items and sometimes may be referred to as the following items hereinafter: client, user device, mobile station, mobile user, mobile terminal subscriber, user, remote station, access terminal, receiver, and mobile unit, etc., and may describe a remote user of a wireless resource in a wireless communication network.

Similarly, the term “base station” used here may be regarded synonymous to the following items and may sometimes be referred to as the following items hereinafter: node B, evolved node B, eNodeB, transceiver base station (BTS), RNC, etc., and may describe a transceiver communicating with a mobile station and provide radio resources in radio communication networks across a plurality of technical generations. Besides the capability of implementing the method discussed here, the base station in discussion may have all functions associated with traditional well-known base stations.

The method discussed infra (some of which are illustrated through flow diagrams) may generally be implemented through hardware, software, firmware, middleware, microcode, hardware description language or any combination thereof. When it is implemented with software, firmware, middleware or microcode, the program code or code segment for executing necessary tasks may be stored in a machine or a computer readable medium (e.g., storage medium). (One or more) processors may implement the necessary tasks.

The specific structures and function details disclosed here are only representative, for a purpose of describing the exemplary embodiments of the present disclosure. Instead, the present disclosure may be specifically implemented through many alternative embodiments. Therefore, it should not be appreciated that the present disclosure is only limited to the embodiments illustrated here.

It should be understood that although terms like “first” and “second” might be used here to describe respective units, these units should not be limited by these terms. Use of these terms is only for distinguishing one unit from another. For example, without departing from the scope of the exemplary embodiments, a first unit may be referred to as a second unit, and similarly the second unit may be referred to as the first unit. The term “and/or” used here includes any and all combinations of one or more associated items as listed.

It should be understood that when one unit is “connected” or “coupled” to a further unit, it may be directly connected or coupled to the further unit, or an intermediate unit may exist. In contrast, when a unit is “directly connected” or “directly coupled” to a further unit, an intermediate unit does not exist. Other terms (e.g., “disposed between” VS. “directly disposed between,” “adjacent to” VS. “immediately adjacent to,” and the like) for describing a relationship between units should be interpreted in a similar manner.

The terms used here are only for describing preferred embodiments, not intended to limit exemplary embodiments. Unless otherwise indicated, singular forms “a” or “one” used here are also intended to include plural forms. It should also be appreciated that the terms “comprise” and/or “include” used here prescribe existence of features, integers, steps, operations, units and/or components as stated, but do not exclude existence or addition of one or more other features, integers, steps, operations, units, components, and/or a combination thereof.

It should also be noted that in some alternative embodiments, the functions/actions as mentioned may occur in an order different from what is indicated in the drawings. For example, dependent on the functions/actions involved, two successively illustrated diagrams may be executed substantially simultaneously or in a reverse order sometimes.

Unless otherwise defined, all terms (including technical and scientific terms) used here have the same meanings as generally understood by those skilled in the art to which the exemplary embodiments relate. It should also be understood that unless explicitly defined here, those terms defined in common dictionaries should be construed to having meanings consistent with those in the context of a related art, and should not be construed according to ideal or too formal meanings.

Some parts of the exemplary embodiments and corresponding detailed depictions are provided through software or algorithms within a computer memory and symbol representations for operating data bits. These depictions and representations are depictions and representations used by a person skilled in the art to effectively convey the essence of his/her work to other technical persons in the art. As usually used, the term “algorithm” used here is envisaged a sequence of inherently consistent steps for obtaining a desired result. The steps refer to those steps that need physical manipulation of physical quantities. Generally, but not necessarily, these quantities adopt forms of optical, electric or magnetic signals that can be stored, transmitted, combined, compared and otherwise manipulated. Mainly for the sake of common use, it has been proved that it is sometimes convenient to refer to these signals as bits, numerical values, elements, symbols, characters, items, and digits.

the depiction hereinafter, illustrative embodiments may be described with reference to symbol representations (e.g., in the form of flow diagrams) of actions and operations that may be implemented as program modules or function processing. The program modules or function processing include routines, programs, objects, components, and data structures and the like which implement specific tasks or implement specific abstract data types, and may be implemented using existing hardware at existing network elements. Such existing hardware may include one or more central processing units (CPUs), digital signal processors (DSPs), specific integrated circuits, field programmable gate array (FPGA) computers, etc.

However, it should be aware that all of these and similar terms should be associated with appropriate physical quantities and are only employed as convenient tags for these quantities. Unless explicitly stated otherwise or clearly seen from the discussion, terms such as “processing,” “computing,” “determining” or “displaying” refer to actions and processing of a computer system or a similar electronic computing device, which manipulates data represented as physical and electronic quantities in a register or memory of the computer system, and such data are transformed into other data similarly represented as physical quantities in the computer system memory or register or other devices for storing, delivering or displaying such kind of information.

It should also be noted that software-implemented aspects of the exemplary embodiments are generally encoded on a program storage medium of a certain form or implemented through a certain type of transmission mediums. The program storage medium may be a magnetic (e.g., a floppy disk or hard disk driver) or optical (e.g., CD ROM) storage medium, and may be a read-only or random access storage medium. Similarly, the transmission medium may be a twisted pair, co-axial cable, optical fiber or certain other appropriate transmission medium well known in the art. The exemplary embodiments are not limited by these aspects in any given implementation manner.

The processor and the memory may jointly operate to run apparatus functions. For example, the memory may store code segments regarding the apparatus functions, while the code segments may also be executed by the processor. Besides, the memory may store processing variables and constants available for the processor.

The Inventors of the present disclosure creatively proposes that upon improvement of RTT by shortening the total delay so as to shorten its length, the base station and the UE should be treated discriminatively. Specifically, the time reserved for the base station and the UE for processing HARQ process should be preferably different. In the present disclosure, the time assigned by the user equipment for itself to process the HARQ process is T1, and the time assigned by the base station for itself to process HARQ is T2, T1 being preferably longer than T2. T1 is also referred to as user equipment HARQ time, and T2 is also referred to as HARQ time.

Hereinafter, embodiments of the present disclosure will be understood more clearly by analyzing the structure of RTT.

For LTE or LTE-A, the uplink (i.e., the user equipment transmits uplink data, and the base station returns a reception response like ACK/NACK) employs a synchronous HARQ. The HARQ process for uplink data transmission. The two portions are embodied into different contents in different examples, respectively, which will be introduced below. Because the first portion thereof is always used as user equipment HARQ time, it is categorized to T1, and because the second portion thereof is always used as base station HARQ time, it is categorized to T2.

Example 1: the first portion is a time interval between uplink resource assignment (UL grant) on PDCCH and (first time) transmitting of uplink data using the assigned uplink resource over PUSCH (physical uplink shared channel); it is seen that this period of time is mainly for the UE to process data, such that it may be categorized to T1.

The second portion is a time interval between uplink data transmission (e.g., via PUSCH; it may be initial transmission or retransmission) and subsequent HARQ feedback (or referred to as reception response) provided by the base station with respect to the data transmission. It is seen that this period of time is mainly for the base station to receive and process the uplink data with an ACK message (indicating acknowledgement) or NACK message (indicating non-acknowledgement) being generated; therefore, it may be categorized to T2.

Particularly, according the embodiments of the present disclosure, T1 is longer than T2.

Example 2: the first portion is a time interval between reception of a NACK message for a certain uplink data transmission by UE (e.g., via PHICH) and retransmission of the same uplink data (e.g., via PUSCH) triggered by the NACK message. It is seen that this period of time is mainly for the UE to process the received NACK message and organize retransmission; therefore, it belongs to the user equipment HARQ time, categorized to T1.

The second portion is still a time interval between uplink data transmission (e.g., via PUSCH; it may be initial transmission or retransmission) and subsequent HARQ feedback (or referred to as reception response) provided by the base station with respect to the data transmission. It is seen that this period of time is mainly for the base station to receive and process the uplink data with an ACK message (indicating acknowledgement) or NACK message (indicating non-acknowledgement) being generated; therefore, it may be categorized to T2.

Particularly, according to the embodiments of the present disclosure, T1 is longer than T2.

Before introducing the embodiments of the present disclosure of the present invention, for an FDD-based radio communication network, the length of T1 is identical to that of T2, both of which are set to 4 sub-frames. Then, the RTT of the uplink HARQ is equal to a sum of T1 and T2, i.e., 8 sub-frames (if each sub-frame is 1 ms, the RTT is 8 ms in total).

Refer to FIG. 3, in which a schematic block diagram of a first assigning apparatus 32 that assigns user equipment HARQ time in a user equipment according to embodiments of the present disclosure is presented. The user equipment HARQ time T1 is for the user equipment to process the HARQ process, wherein the user equipment HARQ time T1 assigned by the first assigning apparatus 32 is longer than the base station HARQ time T2 assigned by the base station, the base station HARQ time T2 being for the base station to process the HARQ process. This core idea has been expounded above.

Continue to refer to FIG. 3, in which the user equipment HARQ time T1 assigned by the first assigning apparatus 32 is also preferably shorthand than a time interval k between a third message (also referred to as MSG3) and a random access response message (e.g., Random Access Response, RAR) between the UE and the base station. namely, k>T1>T2.

Specifically, the MSG3 in the random access process is also applicable to the uplink HARQ. The time interval k (i.e., the time interval between MSG3 and the corresponding RAR) may be 6 sub-frames for FDD. For LTE and LTE-A, the downlink transmission is suitable for asynchronous HARQ. For FDD, the time interval between the downlink data transmission performed by the base station and the reception acknowledgement (ACK or NACK) provided by the UE for the downlink data may also be represented as T1, i.e., the user equipment HARQ time of the UE (receiving, processing, and generating a corresponding reception response).

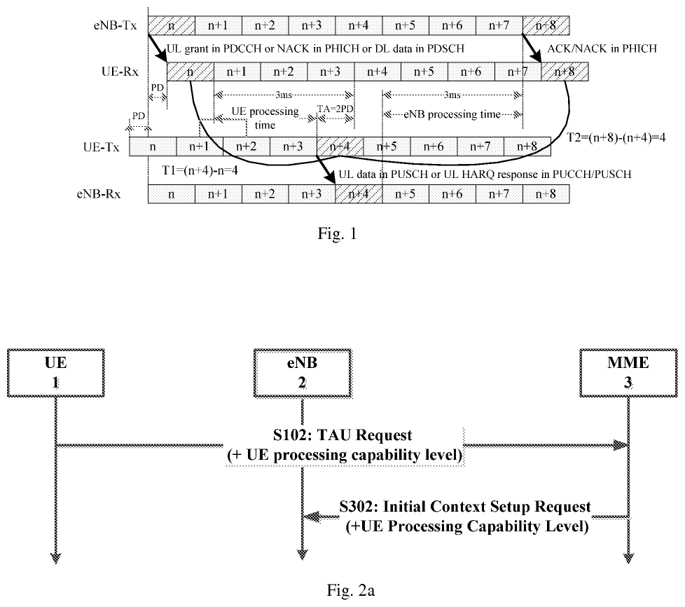

One example of an FDD-based HARQ timing solution is shown in FIG. 1. Suppose the UE and the base station face the same propagation delay (represented as PD in FIG. 1), it may be seen that the base station HARQ time reserved for the base station is longer than the HARQ time reserved for the UE. The UE needs to transmit uplink data earlier than its frame timing based on a parameter TA (Timing Advance). Therefore, the relationship between the base station HARQ time and the user equipment HARQ under this assumption may be expressed by equation (1):

base station HARQ time

=user equipment HARQ time+TA

=user equipment HARQ time+2*PD (1)

However, the inventors of the present disclosure propose that it is unreasonable to reserve a longer HARQ time for the base station than the user equipment, i.e., T1 should not be equal to T2.

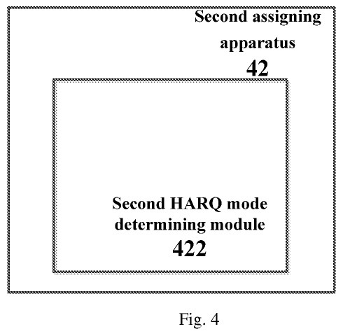

Specifically, according to the embodiments of the present disclosure, with reference to FIGS. 3 and 4, the HARQ timing schemes between the UE and the base station in the FDD-based system are asymmetric, i.e., the base station HARQ reserved for the base station is different from the user equipment HARQ time reserved for the user equipment; moreover, three parameters in the HARQ timing scheme is further defined, i.e., k, T1, and T2 as mentioned above, among which the relation in equation (2) is satisfied:

K>T1>T2 (2)

where k denotes a time interval between MSG3 and the corresponding RAR.

Particularly, T1 (excluding PD) denotes a time interval between uplink resource assignment and uplink data transmission, or a time interval between the NACK message received by the UE and the corresponding uplink data retransmission, or a time interval between reception of the downlink data by the UE and providing a corresponding reception acknowledge (ACK or NACK) to the base station by the UE.

Particularly, T2 denotes a time interval between reception of the uplink data by the base station and providing the corresponding reception response to the user equipment by the base station, or a time interval between reception of the NACK message from the UE by the base station and performing retransmission of corresponding downlink data by the base station.

Without loss of generality, the lengths of k, T1, and T2 are all integral times of TTI.

By shortening T2 (e.g., making it less than T1) compared with the situation above, it is facilitated to shorten the RTTs of the uplink and downlink HARQs, i.e., facilitated to shorten the total delay. T2 is associated with the (processing) capability of the base station. In the specification, the capability of the base station may be defined quantitatively, which will not be detailed here.

The RTT of the HARQ may be further implemented by allowing the user equipment to have a higher processing capability. Specifically, the first assigning apparatus 322 may determine the user equipment HARQ time based on the processing capability of the user equipment. For example, because both k and T1 are associated with the UE's processing capability, different levels of user equipment processing capability may be supported between the base station and the UE. Preferably, for different levels of user equipment processing capabilities (hereinafter referred to as processing capability level), the user equipment HARQ time T1 determined by the first assigning apparatus 322 may be different. More specifically, for different processing capability levels i, the base station may maintain a mapping table including parameter pairs (ki, T1i) corresponding to respective UEs. Subsequently, by querying the mapping table, the base station may know which parameter pair (ki, T1i) should be adopted for a certain UE. the UE's processing capability level may be provided by the UE to the network end, e.g., directly sending it to the base station, or forwarding it to the base station through an MME (Mobility Management Element).

Shortening of the processing delay may be independent of the sTTI solution. For example, a base station or UE that does not support sTTI may pursue reduction of the RTT by only shortening its processing time (e.g., shortening T1) without shortening TTI. However, a base station and a user equipment what support sTTI may benefit from both, i.e., shortened TTI (sTTI) and shortened processing time, to obtain a shorter uplink and downlink delay. In the situation of sTTI, the HARQ timing parameters k, T1 and T2 in all HARQ timing schemes are preferably associated with the length of sTTI. For a given sTTI length, support of one or more user equipment processing capability levels may be provided.

If a synchronous HARQ is adopted, the RTT of a general HARQ process is equal to T1+T2. The RTT of the HARQ process of MSG3 is equal to k+T2. If an asynchronous HARQ is adopted, the user-side T1 defines an HARQ timing of a normal HARQ process, k defines an HARQ timing of the HARQ process of MSG3, and T2 defines an HARQ timing of a normal HARQ process at the base station side, wherein, importantly, k>T1>T2.

According to a more specific embodiment of the present invention, suppose 3 kinds of sTTI configurations (different sTTI lengths) and two different user equipment processing capability levels a, b are supported between the user equipment and the base station. for a UE, it should at least support a normal TTI. If the UE supports sTTI, it may support one or more sTTI configurations.

Table 1 shows different situations of the HARQ parameters:

| | | | | | Base station |
|---|---|---|---|---|---|
| | UE processing | | UE processing | | HARQ time |
| | capability | | capability | | (processing |
| | level a | | level b | | time) |
| normal TTI | T1ₐ₁ | kₐ₁ | T1_{b1} | k_{b1} | T2 |
| (e.g., 1 ms) | | | | | |
| sTTI = 0.5 ms | T1a2 | kₐ₂ | T1_{b2} | k_{b2} | T2 |
| sTTI = 3 | | | | | |
| OFDM | T1ₐ₃ | kₐ₃ | T1_{b3} | k_{b3} | T2 |
| symbols | | | | | |
| sTTI = 2 | T1ₐ₄ | kₐ₄ | T1_{b4} | k_{b4} | T2 |
| OFDM | | | | | |
| symbols | | | | | |

T1s and ks corresponding to different combinations of TTI/TTIs configuration and UE processing capability level are represented with different subscripts so as to embody that the parameters T1 and k may vary with TTI or vary with UE processing capability levels. However, preferably, among all these examples, kij>T1ij>T2j, wherein i denotes a level of UE processing capability level, and j denotes identifiers configured for different TTIs/sTTIs.

The processing latencies of UE and base station may be independent of the length of sTTI, while the processing capability of the base station is generally a constant determined by the system, generally an integral multiple of the length of the sTTI. For different UE processing capability levels (which may also be integral multiples of the sTTI length), a pair of parameters (T1ij, kij) shown in Table 1 are defined, and their values are associated with a length of the corresponding sTTI.

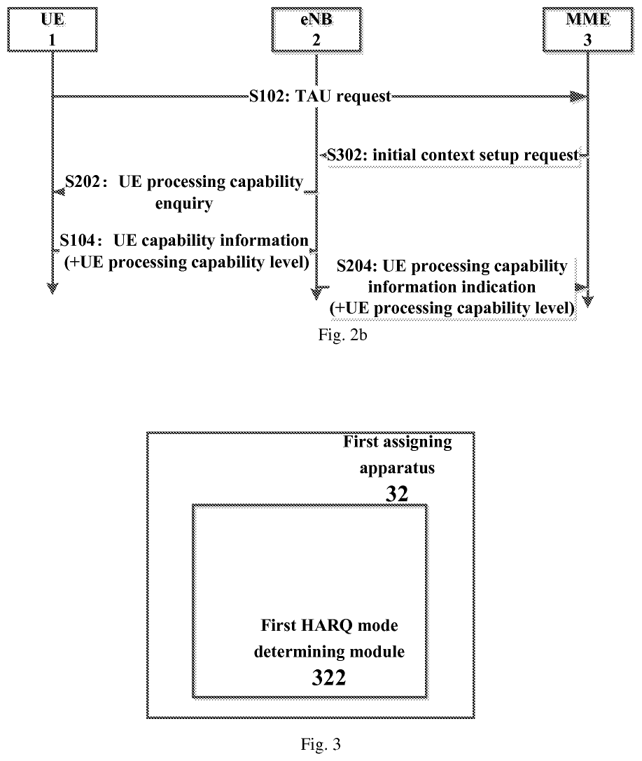

Refer to FIG. 2, in step S102, UE1 reports its processing capability level to the MME3, which may be specifically transmitted through a tracking area update (TAU) request message. Afterwards, in step S302, the MME3 notifies it to the base station 2, e.g., via an initial context setup request message. To this end, a new information element (IE) may be added in the TAU request message and the initial context setup request message, respectively. Specifically, the “UE process capability level” may be added into the corresponding “UE wireless capability” IE.

Refer to FIG. 2b, if the UE1 is performing an Attach process, or performs a TAU process for first connection to the network, or performs a TAU process for updating a UE radio capability, the MME3 might not transmit the UE's radio capability information to the base station in the initial context setup request message. When step S103 is identical to FIG. 2a, the initial context setup request in step S302 will not include relevant information about the UE's processing capability level, which may trigger a new step S202 in which the base station 2 queries its UE processing capability to UE1, and in later step S104, the UE1 directly reports its UE processing capability level to the base station 2. Next, in step S204, the base station transmits the received UE processing capability level information of UE1 as a UE processing capability information indication to the MME3. Similar to FIG. 2a, in the example shown in FIG. 2b, a message/signaling may add a corresponding information element to an interaction of the UE processing capability level information when necessary, which will not be detailed here.

Next, a specific recommendation about HARQ timing in the embodiments of the present invention will be illustrated. With reference to FIG. 3, the first assigning apparatus 32 further comprises a first HARQ mode determining module 322 configured to determine an HARQ mode between the base station 2 and the UE1, the HARQ mode being dependent on at least one of the following items:
cell coverage;
distance between the base station 2 and the user equipment 1;
length of transmission time interval, e.g., generally TTI=1 ms, or a length of sTTI formed by a plurality of OFDM symbols;
processing capability of UE1.

Preferably, the HARQ mode is dependent on all of the above items.

Furthermore, the first HARQ model determining module 322 is configured to determine, for data received on the n^{th} TTI, determine an HARQ process processing result after m TTIs, wherein determining of m follows equation (3):

m=RTT/TTI/2 (3)

Where RTT denotes an HARQ round-trip time, TTI denotes a length of transmission time interval, and RTT is further represented as RTT=2PD+2TTI+D_{UE}+D_{eNB}, where PD denotes a maximum propagation delay between the base station and the user equipment, 2TTI denotes time occupied by data/feedback/message transmission, DUE denotes processing delay at UE, and DeNB denotes processing delay at the base station.

Further, DUE is represented as m_{UE}*TTI+FD_{UE}, wherein m_{UE}*TTI denotes a portion varying with TTI length in the HARQ process processing delay of the UE, FD_{UE} denotes a portion not varying with TTI in the HARQ process processing delay of the UE, D_{eNB} is further represented as m_{eNB}*TTI+FD_{eNB}, wherein m_{eNB}*TTI is a portion varying with TTI length in the HARQ process processing delay of the base station, and FD_{eNB} is a portion not varying with TTI in the HARQ process processing delay of the base station.

The definition above is based on the following consideration:

The total delay may be regarded as comprising a propagation delay (PD) and a processing delay, which should be analyzed separately. Particularly, the propagation delay is decided by a distance between the base station and the UE. In consideration of multi-path propagation and other possible factors, the maximum propagation delay may be nearly twice of the line-of-sight time. Due to processing performance of device hardware, the processing delay will be more complex.

Another important idea of the design scheme of HARQ timing lies in designing a variable HARQ timing, wherein the variant is the m mentioned above, specifically determined by cell coverage, distance between the UE and the base station, hardware processing capability of the UE/base station, and length of TTI.

The difference between different HARQ modes lies in the value of m, e.g., m=2, 3, 4, 5, 6, 7, . . . ; different TTI lengths may support different values of m. For cells under control of each base station or each UE and the base station served thereby, an appropriate sTTI configuration and a corresponding matching HARQ model (e.g., m=2, or 3 or 4 . . . 7 . . . ) may be selected. Due to multi-path transmission and other factors, PD may be determined as twice the time of line-of-sight transmission.

The reception time may be slightly larger than 1 TTI. The total time of HARQ soft cache and decoding time is dependent to a great extent on hardware performance of the UE and the base station, particularly the hardware performance of the UE. Simulation shows that 1.5 TTI is believed to be an upper limit of these fixed time overheads. In actual applications, these parameters should also be further analyzed for the UE and the base station.

To facilitate analysis, the fixed delay may be assumed to be 0.2 ms. This parameter should be further analyzed for the UE and the base station in the application.

Hereinafter, the abovementioned HARQ timing scheme will be illustrated through several specific examples.

### Example 1

For a large cell, its theoretical maximum cell coverage is 107 km; therefore, the corresponding signal transmission time is 0.375 ms. Suppose PD=0.6 ms, m_{UE}=m_{eNB}=1.5, PD_{UE}=FD_{eNB}=0.2 ms; then a limitation of feedback time and an RTT value of the HARQ may be calculated, as illustrated in table 2:

TABLE 2
Limit Values of Feedback Time and HARQ RTT for Large Coverage Cell

| | Normal | | | | | | | | | |
|---|---|---|---|---|---|---|---|---|---|---|
| TTI Length | (e.g., 1 ms) | | 7 OSs | | 3 OSs | | 2 OSs | | 1 OS | |
| TTI | 1 | ms | 0.5 | ms | 0.25 | ms | 0.14286 | ms | 0.07143 | ms |
| PD | 0.714 | ms | 0.714 | ms | 0.714 | ms | 0.714 | ms | 0.714 | ms |
| m_{uE} * TTI, | 1.5 | ms | 0.75 | ms | 0.375 | ms | 0.21429 | ms | 0.107145 | ms |
| m_{eNB} * TTI | | | | | | | | | | |
| FD_{UE}, FD_{eNB} | 0.2 | ms | 0.2 | ms | 0.2 | ms | 0.2 | ms | 0.2 | ms |
| Time limit | 3.414 | ms | 2.164 | ms | 1.539 | ms | 1.27114 | ms | 1.09257 | ms |
| of feedback | | | | | | | | | | |
| Reception | n + 4 | | n + 5 | | n + 7 | | n + 9 | | n + 16 | |
| response | | | | | | | | | | |
| HARQ | | | | | | | | | | |
| Feedback | | | | | | | | | | |

| | | | | | |
|---|---|---|---|---|---|
| HARQ RTT | 8TTI | 10TTI | 14TTI | 18TTI | 32TTI |

It is easily seen from Table 2 that when the TTI length is smaller than or equal to 3 OFDM symbols, in the scenario of large cell, PD will become a main delay factor, and the advantages of using a shorter TTI will also vanish. This means if the TTI length is 1 or 2 OFDM symbols, the HARQ feedback time and RTT will not be proportionally downsized with TTI. As previously mentioned, the traditional m=4 HARQ timing scheme (i.e., n+4) cannot work well when the TTI length is very short.

In practice, if the distance between the base station and the UE is very large, the base station preferably does not select a very short TTI due to the longer RTT. Because shortening of the delay derived from the shortened TTI is counteracted by the longer HARQ RTT.

### Example 2

Consider a normal cell with a coverage of about 14 km. The maximum signal transmission time is 0.047 ms, and the PD value is supposed to be 0.1 ms. With other suppositions being unchanged, calculation may be made as shown in Table 3:

TABLE 3
Limit Values of Feedback Time and HARQ RTT for Normal Cell

| | Normal | | | | | | | | | |
|---|---|---|---|---|---|---|---|---|---|---|
| TTI Length | (e.g., 1 ms) | | 7 OSs | | 3 OSs | | 2 OSs | | 1 OS | |
| TTI | 1 | ms | 0.5 | ms | 0.25 | ms | 0.14286 | ms | 0.07143 | ms |
| PD | 0.1 | ms | 0.1 | ms | 0.1 | ms | 0.1 | ms | 0.1 | ms |
| m_{uE} * TTI, | 1.5 | ms | 0.75 | ms | 0.375 | ms | 0.21429 | ms | 0.107145 | ms |
| m_{eNB} * TTI | | | | | | | | | | |
| FD_{UE}, FD_{eNB} | 0.2 | ms | 0.2 | ms | 0.2 | ms | 0.2 | ms | 0.2 | ms |
| Time limit of | 2.8 | ms | 1.55 | ms | 0.925 | ms | 0.65714 | ms | 0.47857 | ms |
| feedback | | | | | | | | | | |
| Reception | n + 3 | | n + 4 | | n + 4 | | n + 5 | | n + 7 | |
| response | | | | | | | | | | |
| (HARQ | | | | | | | | | | |
| feedback | | | | | | | | | | |

| | | | | | |
|---|---|---|---|---|---|
| HARQ RTT | 6TTI | 8TTI | 8TTI | 10TTI | 14TTI |

In practice, if the base station selects a shorter TTI for the UE, the base station should estimate location of the UE (i.e., the distance between the base station and the UE) and hardware processing capability (especially of the UE), and then selects an appropriate HARQ model for the UE. The specific HARQ mode selection may surely be performed by the UE, as long as it obtains relevant information needed by selection; or the UE may passively know the HARQ mode already selected by the base station as mentioned above.

### Example 3

Density of base stations in urban areas is usually far higher than suburb areas. At this point, the distance between base stations is usually smaller than 1 km. Table 4 briefly shows each HARQ feedback configuration. It may be seen that based on the previous assumption, the UE nearby the base station may obtain n+3 feedback timing when TTI is shortened to half or even one quarter, i.e., m=3. However, UEs in the border of the cell which are relatively distant away from the base station can only obtain n+7 feedback timing when the TTI length is shortened to 1 OFDM symbol, i.e., m=7. Different TTI lengths and UE locations preferably correspond to different HARQ modes.

TABLE 4
Distance-Related Different HARQ Feedback Time Limits

| | Distance (km) | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Normal | n + 3 | n + 3 | n + 3 | n + 3 | n + 3 | n + 3 | n + 3 | n + 3 | n + 3 | n + 3 | n + 3 | n + 3 | n + 3 | n + 3 |
| TTI | | | | | | | | | | | | | | |
| 7-OS | n + 3 | n + 3 | n + 3 | n + 3 | n + 3 | n + 3 | n + 3 | n + 4 | n + 4 | n + 4 | n + 4 | n + 4 | n + 4 | n + 4 |
| TTI | | | | | | | | | | | | | | |
| 3-OS | n + 4 | n + 4 | n + 4 | n + 4 | n + 4 | n + 4 | n + 4 | n + 4 | n + 4 | n + 4 | n + 4 | n + 4 | n + 4 | n + 4 |
| TTI | | | | | | | | | | | | | | |
| 2-OS | n + 4 | n + 4 | n + 5 | n + 5 | n + 5 | n + 5 | n + 5 | n + 5 | n + 5 | n + 5 | n + 5 | n + 5 | n + 5 | n + 5 |
| TTI | | | | | | | | | | | | | | |
| 1-OS | n + 6 | n + 6 | n + 6 | n + 6 | n + 6 | n + 6 | n + 6 | n + 7 | n + 7 | n + 7 | n + 7 | n + 7 | n + 7 | n + 7 |
| TTI | | | | | | | | | | | | | | |

In practice, the base station may determine the furthest distance of the UE based on the mobility of the UE, base station density, and cell reselection, and take the furthest distance into consideration.

With reference to FIG. 4, a second assignment apparatus 42 is configured to assign base station HARQ time, the base station HARQ time being for the base station to process an HARQ process, wherein the base station HARQ time assigned by the second assigning apparatus is shorter than a user equipment HARQ time assigned by the user equipment, the user equipment HARQ time being for the user equipment to process the HARQ process.

Further, the user equipment HARQ time is shorter than a time interval between a radio resource control request message and a random access response message between the user equipment 1 and the base station 2.

Further, the second assigning apparatus 42 also comprises:

a second HARQ mode determining module configured to determine an HARQ mode between the base station and the user equipment, wherein the HARQ mode is dependent on at least any one of the following items:
cell coverage;
distance between the base station 2 and the user equipment 1;
transmission time interval (TTI) length;
processing capability of the user equipment.

Further, the second HARQ mode determining module 422 is configured to determine, for data received on the n^{th} TTI, to transmit an HARQ process processing result after m TTIs, wherein determining of the m follows the equation (3):

m=RTT/TTI/2,

where RTT denotes an HARQ round-trip time, TTI denotes a length of a transmission time interval, and the RTT is further represented as: RTT=2PD+2TTI+DUE+DeNB, wherein PD denotes a maximum propagation delay between the base station and the user equipment, 2TTI denotes time occupied by transmitting the data/feedback/message, DUE denotes processing delay at the UE, and DeNB denotes processing delay at the base station.

Further, D_{UE} is further represented as m_{UE}*TTI+FD_{UE}, wherein m_{UE}*TTI is a portion varying with TTI length in an HARQ process processing delay of the UE, FD_{UE} is a portion not varying with the TTI in the HARQ process processing delay of the UE, and D_{eNB} is further represented as m_{eNB}*TTI+FD_{eNB}, wherein m_{eNB}*TTI denotes a portion varying with TTI length in the HARQ process processing delay of the base station 2, and FD_{eNB} is the portion not varying with TTI of the HARQ process processing delay of the base station.

Other or further contents of the second assigning apparatus 42 may refer to the introduction above with respect to FIG. 3, which will not be detailed here.

It should be noted that the present invention may be implemented in software and/or a combination of software and hardware. For example, various modules of the present invention may be implemented using an application-specific integrated circuit (ASIC) or any other similar hardware devices. In one embodiment, the software program of the present invention may be executed by the processor to implement the steps or functions above. Likewise, the software program (including a relevant data structure) of the present invention may be stored in a computer-readable recording medium, e.g., a RAM memory, a magnetic or optical driver or a floppy disk and a similar device. In addition, some steps or functions of the present invention may be implemented by hardware, e.g., as a circuit cooperating with the processor so as to execute respective steps or functions.

To those skilled in the art, it is apparent that the present invention is not limited to the details of the illustrative embodiments, and without departing from the spirit or basic feature of the present invention, the present invention can be implemented in other specific form. Therefore, in any perspective, the embodiments should be regarded as illustrative, not limitative. The scope of the present invention is limited by the appended claims, rather than the depiction above. Therefore, all variations within the meanings and scopes of equivalent elements of the claims are covered within the present invention. No reference numerals in the claims should be regarded as limiting the involved claims. Besides, it is apparent that the word “comprise” or “include” does not exclude other units or steps, and a singular form does not exclude plurality. A plurality of units or modules stated in a system claim may also be implemented by one unit or module through software or hardware. Words like the first and second are used to indicate names, not indicating any specific sequence.

Although the exemplary embodiments have been specifically illustrated and described above, those skilled in the art will understand that without departing from the spirit and scope of the claims, its forms and details may be varied. Protection as sought here are stated in the appended claims.

1. A first assigning apparatus for assigning user equipment HARQ time in a user equipment of a radio communication network, the user equipment HARQ time being for the user equipment to process an HARQ process, wherein the user equipment HARQ time assigned by the first assigning apparatus is longer than a base station HARQ time assigned by a base station, the base station HARQ time being for the base station to process the HARQ process.

2. The first assigning apparatus according to claim 1, wherein the user equipment HARQ time is shorter than a time interval between a third message and a random access response message between the user equipment and the base station.

3. The first assigning apparatus according to claim 1, wherein the first assigning apparatus is configured to determine the user equipment HARQ time based on a processing capability of the user equipment.

4. The first assigning apparatus according to claim 3, wherein the first assigning apparatus is configured such that user equipment HARQ time determined based on different user equipment processing capability levels is different.

5. The first assigning apparatus according to claim 1, wherein the first assigning apparatus further comprises:
a first HARQ mode determining module configured to determine an HARQ mode between the base station and the user equipment, wherein the HARQ model is dependent on at least one of the following items:
a coverage area of the cell;
a distance between the base station and the user equipment;
transmission time interval (TTI) length;
processing capability of the user equipment.

6. The first assigning apparatus according to claim 5, wherein the first HARQ mode determining module is configured to determine, for data received on the n^{th} TTI, to transmit an HARQ process processing result after m TTIs, wherein determining of m follows the equation below:
m=RTT/TTI/2,
where RTT denotes an HARQ round-trip time, TTI denotes a length of transmission time internal, and RTT is further denoted as: RTT=2PD+2TTI+D_{UE}+D_{eNB}, where PD denotes a maximum propagation delay between the base station and the user equipment, 2TTI denotes time occupied by data/feedback/message transmission, D_{UE} denotes processing delay at the UE, and D_{eNB} denotes processing delay at the base station.

7. The first assigning apparatus according to claim 6, wherein D_{UE} is further represented as m_{UE}*TTI+FD_{UE}, wherein m_{UE}*TTI is a portion varying with a TTI length in a HARQ process processing delay of the UE, FD_{UE} is a portion not varying with TTI in the HARQ process processing of the UE, and DeNB is further represented as m_{eNB}*TTI+FD_{eNB}, where m_{eNB}*TTI is a portion varying with TTI length in an HARQ process processing delay of the base station, and FD_{eNB} is a portion not varying with TTI in the HARQ process processing delay of the base station.

8. A second assigning apparatus for assigning base station HARQ time in a base station of a radio communication network, the base station HARQ time being for the base station to process an HARQ process, where the base station HARQ time assigned by the second assigning apparatus is shorter than a user equipment HARQ time assigned by the user equipment, the user equipment HARQ time being for the user equipment to process the HARQ process.

9. The second assigning apparatus according to claim 8, wherein the user equipment HARQ time is shorter than a time interval between a radio resource control request message and a random access response message between the user equipment and the base station.

10. The second assigning apparatus according to claim 8, wherein the second assigning apparatus also comprises:
a second HARQ mode determining module configured to determine an HARQ mode between the base station and the user equipment, wherein the HARQ mode is dependent on at least any one of the following items:
cell coverage;
distance between the base station and the user equipment;
transmission time interval (TTI) length;
processing capability of the user equipment.

11. The second assigning apparatus according to claim 10, wherein the second HARQ mode determining module is configured to determine, for data received on the n^{th} TTI, to transmit an HARQ process processing result after m TTIs, wherein determining of the m follows the equation below:
m=RTT/TTI/2,
where RTT denotes an HARQ round-trip time, TTI denotes a length of a transmission time interval, and the RTT is further represented as: RTT=2PD+2TTI+D_{UE}+D_{eNB}, wherein PD denotes a maximum propagation delay between the base station and the user equipment, 2TTI denotes time occupied by transmitting the data/feedback/message, D_{UE} denotes processing delay at the UE, and D_{eNB} denotes processing delay at the base station.

12. The second assigning apparatus according to claim 11, wherein D_{UE} is further represented as m_{UE}*TTI+FD_{UE}, wherein m_{UE}*TTI is a portion varying with TTI length in an HARQ process processing delay of the UE, FD_{UE} is a portion not varying with the TTI in the HARQ process processing delay of the UE, and D_{eNB} is further represented as m_{eNB}*TTI+FD_{eNB}, wherein m_{eNB}*TTI denotes a portion varying with TTI length in the HARQ process processing delay of the base station, and FD_{eNB} is the portion not varying with TTI of the HARQ process processing delay of the base station.

13. A user equipment in a radio communication network, comprising a first assigning apparatus according to claim 1.

14. A radio base station, comprising a second assigning apparatus according to claim 8.

15. A method of assigning user equipment HARQ time and base station HARQ time in a radio communication network, wherein the user equipment HARQ time is for the user equipment to process an HARQ process, the base station HARQ time is for the base station to process the HARQ process, the user equipment HARQ time being longer than the base station HARQ time.
